(19) United States
(12) Patent Application Publication
(10) Pub. No.: US 2018/0347422 A1
(43) Pub. Date: Dec. 6, 2018

(54) FINE PARTICLE DETECTOR AND EXHAUST GAS PURIFICATION APPARATUS

(71) Applicant: FUJITSU LIMITED, Kawasaki-shi (JP)

(72) Inventor: Katsusada Motoyoshi, Sagamihara (JP)

(73) Assignee: FUJITSU LIMITED, Kawasaki-shi (JP)

(21) Appl. No.: 15/964,172

(22) Filed: Apr. 27, 2018

(30) Foreign Application Priority Data
May 31, 2017 (JP) 2017-107516

(51) Int. Cl. F01N 3/028; F01N 9/00

(52) U.S. Cl. CPC F01N 3/028; F01N 9/002; F02B 3/06; F01N 2560/12; F01N 2550/04

(57) ABSTRACT

A fine particle detector includes an antenna, an electromagnetic wave generator configured to supply electromagnetic waves to the antenna, an electromagnetic wave detector configured to detect reflected waves of the electromagnetic waves emitted from the antenna, and a controller configured to estimate, based on intensities of the reflected waves detected by the electromagnetic wave detector, an accumulated amount of fine particles.

### CROSS-REFERENCE TO RELATED APPLICATIONS

This application is based upon and claims the benefit of priority of the prior Japanese Patent Application No. 2017-107516, filed on May 31, 2017, the entire contents of which are incorporated herein by reference.

### FIELD

The disclosures herein generally relate to a fine particle detector and an exhaust gas purification apparatus.

### BACKGROUND

Currently, an exhaust gas purification apparatus using a diesel particulate filter (DPF) has been put to practical use as an apparatus for collecting fine particles such as particulate matter (PM) contained in exhaust gas, and is installed in a diesel-engine vehicle and the like. In such an exhaust gas purification apparatus, when fine particles such as PM are accumulated in the DPF by use, functions of the DPF may be lowered or engine power may be reduced. Accordingly, in response to more than a given amount of fine particles such as PM being accumulated in the DPF, the DPF needs to be regenerated. As a method for regenerating the DPF, there exists a method for forcibly regenerating the DPF, for example. According to the method, diesel oil used as fuel in diesel engines is injected into the DPF such that fine particles such as PM accumulated in the DPF are forcibly burned.

As a method for estimating the accumulated amount of fine particles such as PM accumulated in a DPF, there exists a method for measuring a pressure difference between pressure sensors disposed before and after the DPF and estimating the accumulated amount of fine particles such as PM. However, in a practical situation in which a vehicle is operated, the rotation speed of an engine and the amount of fuel consumption change constantly. Therefore, pressure in an exhaust gas pipe is not constant and a pressure difference between the pressure sensors disposed before and after the DPF is not stable. Accordingly, the amount of fine particles such as PM accumulated in the DPF, estimated based on the measured pressure difference, is not accurate and frequently includes errors.

Further, as another method for estimating the accumulated amount of fine particles such as PM accumulated in the DPF, there exists a method for irradiating the DPF with microwaves, and estimating, based on the intensities of the microwaves transmitted through the DPF, the accumulated amount of fine particles such as PM accumulated in the DPF.

However, the method for irradiating the DPF with microwaves requires an antenna and a waveguide for irradiating the DPF with microwaves to be disposed. In general, the antenna and the waveguide are disposed in the flow of exhaust gas. Therefore, the antenna and the waveguide are exposed to exhaust gas containing numerous fine particles such as PM, NOx, and the like.

In the case of the antenna, when fine particles such as PM are attached to the antenna, dielectric characteristics and conductivity of the fine particles such as PM attached to the antenna cause the antenna characteristics to change. As a result, the accumulated amount of the fine particles such as PM accumulated in the DPF is not accurately estimated. Similarly, in the case of the waveguide, when fine particles such as PM are accumulated in the waveguide, the fine particles such as PM accumulated in the waveguide cause the waveguide characteristics to change. As a result, the accumulated amount of the fine particles such as PM accumulated in the DPF is not accurately estimated.

Further, in the case of the antenna, because the antenna is generally formed of a metal, NOx and moisture contained in exhaust gas cause the antenna to be corroded. As a result, the antenna characteristics may change, and further, the antenna itself may fail to function as an antenna. In such a case, the accumulated amount of fine particles such as PM accumulated in the DPF is not accurately estimated. Further, it may become difficult to conduct measurement of fine particles such as PM accumulated in the DPF.

### Related-Art Documents

### Patent Document

[Patent Document 1] Japanese Laid-Open Patent Publication No. 7-119442

[Patent Document 2] Japanese Laid-Open Patent Publication No. 6-212946

[Patent Document 3] Japanese Laid-Open Patent Publication No. 2007-77878

[Patent Document 4] Japanese Laid-Open Patent Publication No. 2011-137445

### SUMMARY

According to an aspect of the embodiment, a fine particle detector includes an antenna, an electromagnetic wave generator configured to supply electromagnetic waves to the antenna, an electromagnetic wave detector configured to detect reflected waves of the electromagnetic waves emitted from the antenna, and a controller configured to estimate, based on intensities of the reflected waves detected by the electromagnetic wave detector, an accumulated amount of fine particles.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A through 1C are drawings illustrating an exhaust gas purification apparatus according to an embodiment;

FIG. 2 is an enlarged view of a main portion of the exhaust gas purification apparatus according to the embodiment;

FIG. 3 is a structural drawing illustrating a semiconductor device used in the exhaust gas purification apparatus;

FIG. 4 is a drawing illustrating an antenna according to the embodiment;

FIG. 5 is a graph illustrating characteristics obtained when the antenna of FIG. 4 is used;

FIG. 6 is a drawing illustrating an antenna used in the exhaust gas purification apparatus according to variation 1 of the embodiment;

FIGS. 7A and 7B are drawings illustrating the exhaust gas purification apparatus according to variation 1 of the embodiment;

FIG. 8 is a graph illustrating characteristics obtained in the exhaust gas purification apparatus according to variation 1 of the embodiment;

FIG. 9 is a drawing illustrating an antenna used in the exhaust gas purification apparatus according to variation 2 of the embodiment;

FIGS. 10A and 10B are drawings illustrating the exhaust gas purification apparatus according to variation 2 of the embodiment;

FIG. 11 is a graph illustrating characteristics obtained in the exhaust gas purification apparatus according to variation 2 of the embodiment;

FIG. 12 is a drawing illustrating an antenna used in the exhaust gas purification apparatus according to variation 3 of the embodiment;

FIGS. 13A and 13B are drawings illustrating the exhaust gas purification apparatus according to variation 3 of the embodiment;

FIG. 14 is a graph illustrating characteristics of the exhaust gas purification apparatus according to variation 3 of the embodiment;

FIG. 15 is a drawing illustrating an antenna used in the exhaust gas purification apparatus according to variation 4 of the embodiment;

FIGS. 16A and 16B are drawings illustrating the exhaust gas purification apparatus according to variation 4 of the embodiment;

FIG. 17 is a graph illustrating characteristics obtained in the exhaust gas purification apparatus according to variation 4 of the embodiment;

FIG. 18 is a drawing illustrating an antenna used in the exhaust gas purification apparatus according to variation 5 of the embodiment;

FIGS. 19A and 19B are drawings illustrating the exhaust gas purification apparatus according to variation 5 of the embodiment;

FIG. 20 is a graph illustrating characteristics obtained in the exhaust gas purification apparatus according to variation 5 of the embodiment;

FIG. 21 is a flowchart illustrating a method for estimating an accumulated amount of fine particles such as PM according to the embodiment; and

FIG. 22 is a flowchart illustrating a method for regenerating a fine particle collector of the exhaust gas purification apparatus according to the embodiment.

### DESCRIPTION OF EMBODIMENTS

In the following, embodiments of the present invention will be described with reference to the accompanying drawings. In the drawings, the same elements are denoted by the same reference numerals.

### (Fine Particle Detector and Exhaust Gas Purification Apparatus)

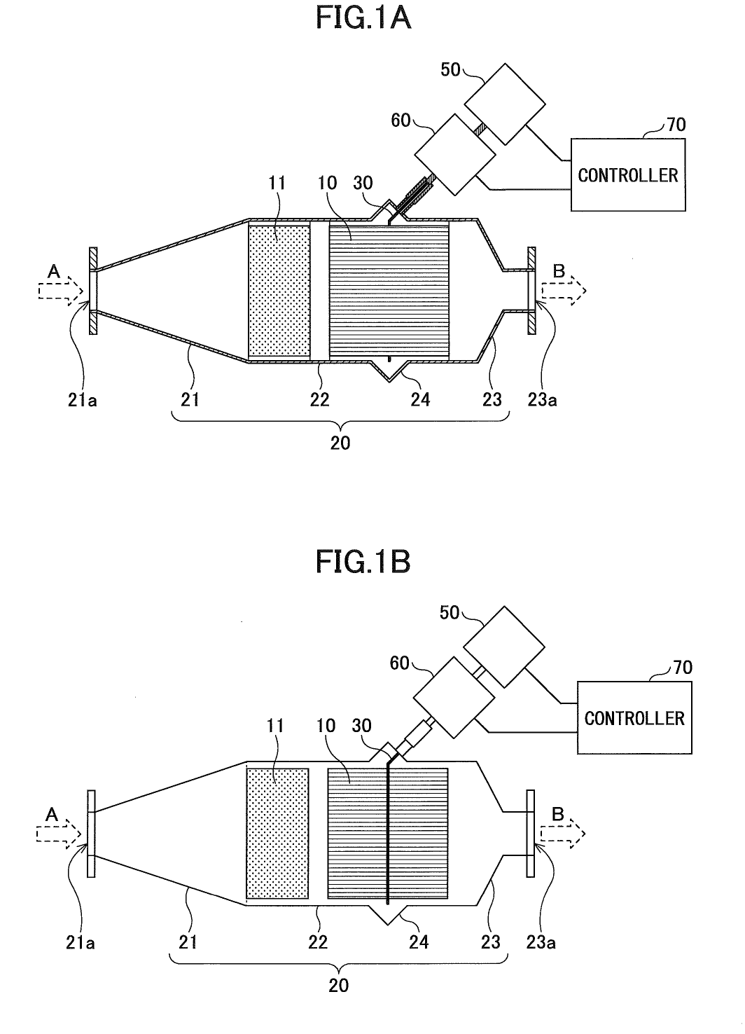

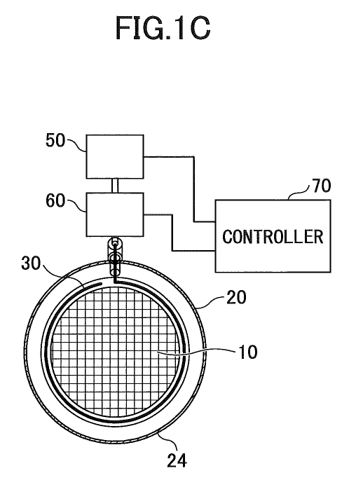

Referring to FIGS. 1A through 1C and FIG. 2, a fine particle detector and an exhaust gas purification apparatus according to an embodiment will be described. FIG. 1A is a cross-sectional view along a direction in which exhaust gas flows in the exhaust gas purification apparatus according to the embodiment. FIG. 1B is a drawing illustrating a structure of the exhaust gas purification apparatus according to the embodiment. FIG. 1C is a cross-sectional view of a part where an antenna is disposed. FIG. 2 is an enlarged view of a main portion of FIG. 1C.

The exhaust gas purification apparatus according to the embodiment includes a fine particle collector 10, an oxidation catalyst part 11, a housing 20, an antenna 30, a microwave generator 50, a microwave detector 60, and a controller 70. Further, the fine particle detector according to the embodiment is configured with an antenna 30, a microwave generator 50, a microwave detector 60, a controller 70, and the like. Also, herein, the microwave generator 50 may be described as an electromagnetic wave generator and the microwave detector 60 may be described as an electromagnetic wave detector. Accordingly, a microwave may be described as an electromagnetic wave.

The fine particle collector 10 is formed of a DPF or the like. For example, the DPF is formed in a honeycomb structure in which adjacent vent holes are alternately closed, and exhaust gas is discharged from vent holes different from those on the inlet side. The oxidation catalyst part 11 is, for example, a diesel oxidation catalyst (DOC) that oxidizes nitric oxide (NO) contained in exhaust gas flowing into the oxidation catalyst part 11 to, for example, nitrogen dioxide (NO₂).

The housing 20 is formed of a metal material, and includes an inlet 21, a housing body 22, and an outlet 23. The fine particle collector 10 and the oxidation catalyst part 11 are housed in the housing body 22. In the exhaust gas purification apparatus according to the embodiment, exhaust gas such as exhaust gas from an engine enters the housing 20 from a direction indicated by a broken line arrow A. To be more specific, exhaust gas enters the housing 20 from an inlet port 21a of the inlet 21, passes through the oxidation catalyst part 11 and the fine particle collector 10 provided in the housing body 22, and is thereby purified. The purified exhaust gas is discharged from an outlet port 23a of the outlet 23 in a direction indicated by a broken line arrow B.

The antenna 30 is placed around the fine particle collector 10. The antenna is placed in an antenna placement area 24 extending outward in the radial direction of the housing body 22 of the housing 20. To be more specific, as illustrated in FIG. 2, a cushioning material 40 such as glass wool for heat insulation is provided between the housing body 22 of the housing 20 and the fine particle collector 10 and also between the housing body 22 of the housing 20 and the oxidation catalyst part 11. The antenna 30 is placed in the cushioning material 40. Namely, the cushioning material 40 is disposed between the fine particle collector 10 and the antenna placement area 24 of the housing body 22 of the housing 20, and the antenna 30 is placed in the cushioning material 40. Therefore, the antenna 30 is placed between the fine particle collector 10 and the antenna placement area 24 of the housing body 22 of the housing 20. In a case where the antenna 30 is placed too close to the antenna placement area 24, microwaves are not sometimes emitted smoothly. Thus, the antenna 30 is placed approximately λ/4 away from the antenna placement area 24, where λ represents the wavelength of a microwave.

The microwave generator 50 is configured to generate microwaves. The microwave detector 60 is configured to detect the intensities of the microwaves. To be more specific, the antenna 30 is coupled to the microwave generator 50, and the microwave detector 60 is disposed between the antenna 30 and the microwave generator 50. The microwave generator 50 is configured to change frequencies of the generated microwaves. The microwave generator 50 uses a semiconductor device, specifically, a high electron mobility transistor (HEMT) using a nitride semiconductor.

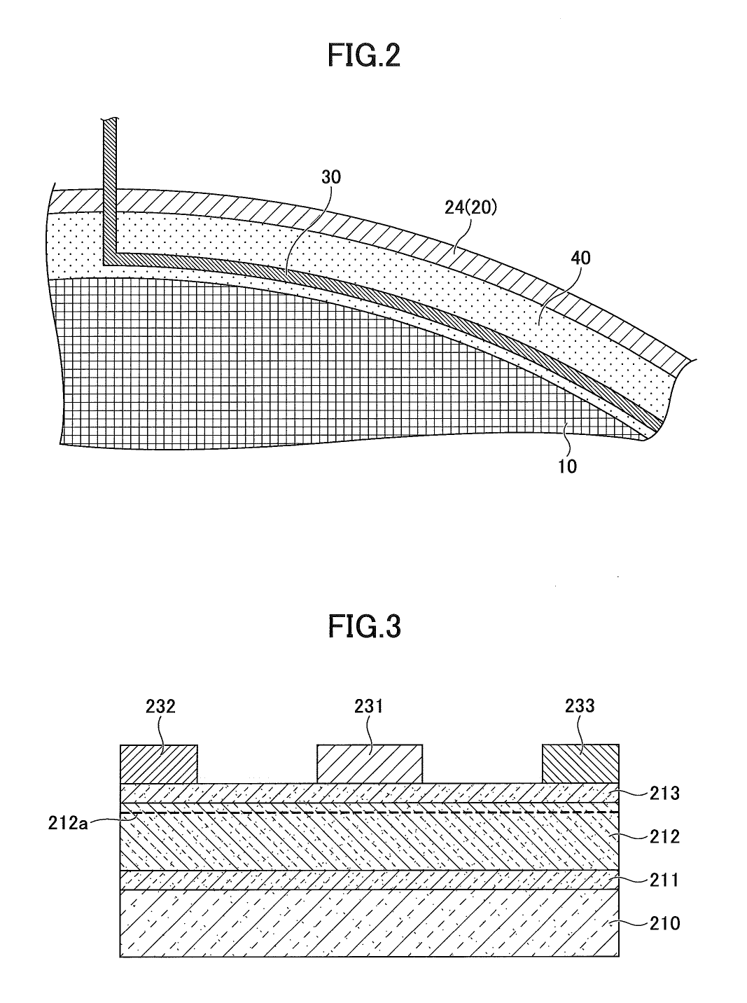

As illustrated in FIG. 3, the HEMT using the nitride semiconductor is formed by laminating nitride semiconductor layers on a substrate 210 such as SiC. Namely, a nucleation layer 211 formed of AlN, an electron transport layer 212, and an electron supply layer 213 are stacked in this order on the substrate 210. The electron transport layer 212 is formed of GaN. The electron supply layer 213 is formed of AlGaN or InAlN. Accordingly, in the electron transport layer 212, a 2DEG 212a is generated in the vicinity of the interface with the electron supply layer 213. A gate electrode 231, a source electrode 232, and a drain electrode 233 are formed on the electron supply layer 213.

In the present embodiment, microwaves generated by the microwave generator 50 are emitted from the antenna 30 through the microwave detector 60 toward the fine particle collector 10. The microwaves that have entered the fine particle collector 10 are absorbed by fine particles such as PM accumulated in the fine particle collector 10. Microwaves not absorbed by fine particles such as PM are returned to the antenna 30 and detected as reflected waves by the microwave detector 60.

The present inventor has found that values of the reflected waves detected by the microwave detector 60 change in accordance with the amount of fine particles such as PM accumulated in the fine particle collector 10. Based on such finding, the present invention is made. To be more specific, upon fine particles such as PM being accumulated in the fine particle collector 10, dielectric characteristics change, causing impedance in the housing 20 to change. Such a change in the impedance is observed as a change in ease of emitting microwaves. In a case where microwaves are easily emitted, the intensities of reflection waves decrease. In a case where microwaves are not easily emitted, the intensities of reflection waves increase. Accordingly, based on such a change in the intensities of reflected waves, it is possible to measure a change in the amount of fine particles such as PM accumulated in the fine particle collector 10. In other words, it is possible to estimate the amount of fine particles such as PM accumulated in the fine particle collector 10.

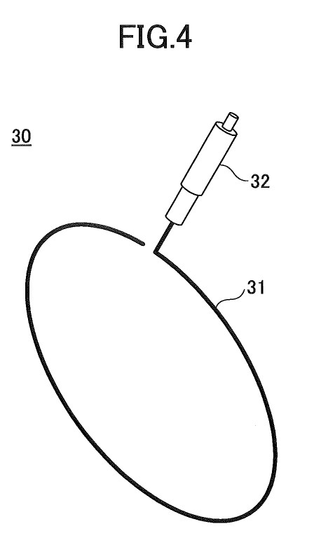

The antenna 30 used in the fine particle detector and the exhaust gas purification apparatus according to the embodiment is described as a loop antenna including a radiation part 31 as illustrated in FIG. 4. The antenna 30 includes the radiation part 31 configured to emit microwaves and a coupling part 32 configured to couple the radiation part 31 to the microwave detector 60. The radiation part 31 is made of a metal material such as stainless steel having a diameter of 1 mm.

In the present embodiment, the microwave generator 50 generates microwaves of frequencies in a range from 2.4 GHz to 2.5 GHz, supplies the microwaves to the antenna 30 by sweeping the frequencies, and causes the radiation part 31 of the antenna 30 to emit the microwaves. The microwave detector 60 detects the intensities of reflected waves. Values of the detected intensities of the reflected waves are sent to the controller 70, and the controller 70 sums the values of the intensities of reflected waves. The summed value of the intensities of the reflected waves is described as a summed reflection intensity.

Further, in a case where microwaves are emitted to the fine particle collector 10, reflected waves detected by the microwave detector 60 include the microwaves of bottom (trough) frequencies. As fine particles such as PM are accumulated, the bottom frequencies may change. Therefore, in a case where microwaves of frequencies in a specific range are emitted, the intensities of reflected waves may repeatedly increase and decrease.

In the present embodiment, microwaves of frequencies in a predetermined range are emitted by sweeping the frequencies, and reflected waves are summed such that the frequencies in the predetermined range are averaged. Accordingly, by averaging the reflected waves, it is possible to obtain relationships in which an increase in the accumulated amount of fine particles such as PM is accompanied with unidirectional increase in the intensities of the reflected waves, and to also obtain relationships in which a decrease in the accumulated amount of fine particles such as PM is accompanied with unilateral increase in the intensities of the reflected waves. In the present embodiment, the accumulated amount of fine particles such as PM is estimated based on the above-described relationships.

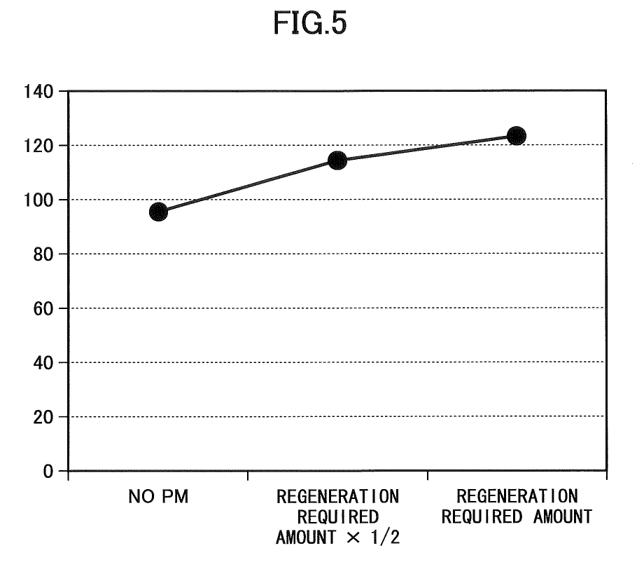

FIG. 5 illustrates a summed reflection intensity obtained by a simulation in each case where no fine particles such as PM are accumulated in the fine particle collector 10 (no PM), fine particles such as PM are accumulated to the extent that the fine particle collector 10 needs to be regenerated (regeneration required amount), and fine particles such as PM are accumulated to half the regeneration required amount (regeneration required amount×½). Further, microwaves are supplied from the antenna 30 by sweeping the frequencies in the range from 2.4 GHz to 2.5 GHz. The vertical axis indicates relative values.

As illustrated in FIG. 5, the summed reflection intensity is approximately 95 in the case where no fine particles such as PM are accumulated in the fine particle collector 10 (no PM), is approximately 115 in the case where the accumulated amount is equal to half the regeneration required amount, and is approximately 123 in the case where fine particles such as PM are accumulated to the extent that the fine particle collector 10 needs to be regenerated (regeneration required amount). Accordingly, as the amount of fine particles such as PM accumulated in the fine particle collector 10 increases, the summed reflection intensity increases. Thus, when the reflection intensity reaches a value corresponding to the regeneration required amount, it can be determined that fine particles such as PM are accumulated to the extent that the fine particle collector 10 needs to be regenerated.

In the present embodiment, the antenna 30 is placed in the cushioning material 40 located on the outer side of the fine particle collector 10. Therefore, fine particles such as PM do not attach to or are not accumulated in the antenna 30, and thus do not cause the characteristics of the antenna 30 to change. Accordingly, the amount of fine particles such as PM accumulated in the fine particle collector 10 can be accurately estimated. Also, because the antenna 30 is placed in the cushioning material 40 located on the outer side of the fine particle collector 10, the antenna 30 is little exposed to NOx contained in exhaust gas, preventing the antenna 30 from being corroded. Therefore, the life of the antenna 30 can be extended and the amount of fine particles such as PM accumulated in the fine particle collector 10 can be estimated with high reliability for a long time.

In the following, the fine particle detector and the exhaust gas purification apparatus with different shapes of antennas will be described. Frequencies of microwaves supplied from the antennas are swept in the range from 2.4 GHz to 2.5 GHz. For convenience, a value of a summed reflection intensity is a relative value.

### (Variation 1)

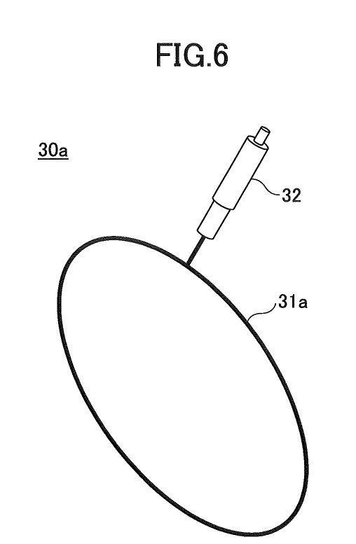

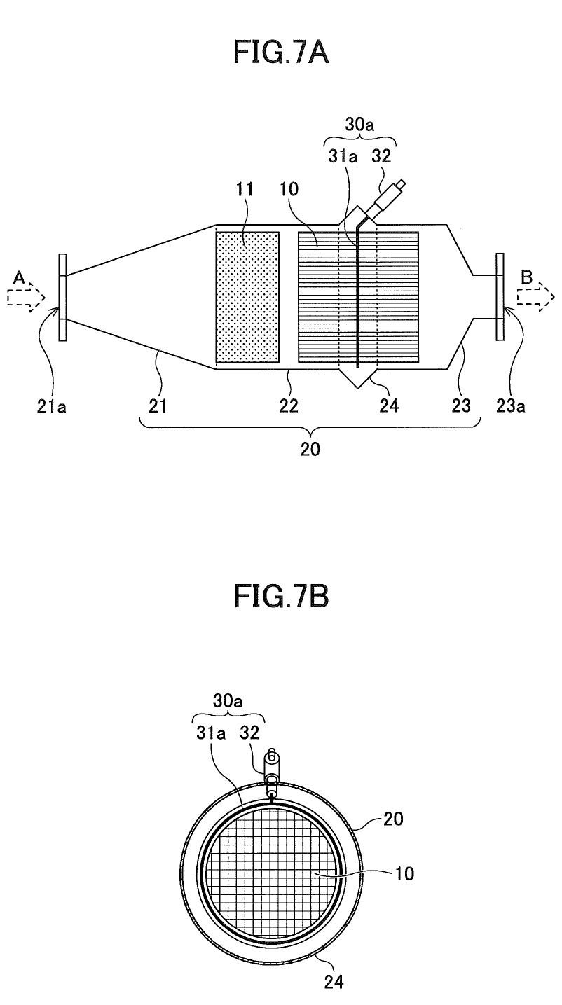

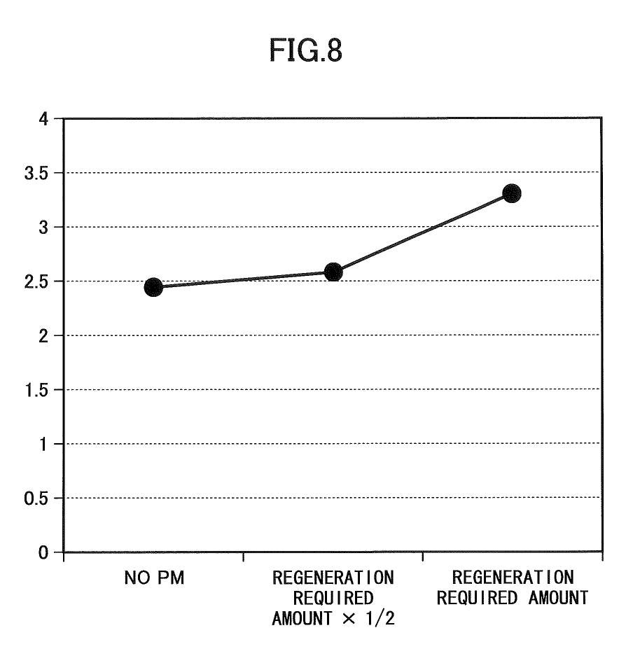

Next, a relationship between an amount of fine particles such as PM accumulated in the fine particle collector 10 and a summed reflection intensity in a case where an antenna 30a of FIG. 6 is used will be described. FIG. 7A is a drawing illustrating a structure of the exhaust gas purification apparatus that uses the antenna 30a of FIG. 6. FIG. 7B is a cross-sectional view of a part where the antenna 30a is provided. FIG. 8 illustrates a result obtained by simulating, in the exhaust gas purification apparatus using the antenna 30a of FIG. 6, the relationship between the amount of fine particles such as PM accumulated in the fine particle collector 10 and the summed reflection intensity. For convenience, the vertical axis indicates relative values. The antenna 30a of FIG. 6 is a ring antenna having a ring-shaped radiation part 31a. The diameter of the ring-shaped radiation part 31a is approximately 1 mm.

As illustrated in FIG. 8, the summed reflection intensity is approximately 2.4 in the case where no fine particles such as PM are accumulated in the fine particle collector 10 (no PM), is approximately 2.6 in the case where the accumulated amount is equal to half the regeneration required amount, and is approximately 3.3 in the case where fine particles such as PM are accumulated to the extent that the fine particle collector 10 needs to be regenerated (regeneration required amount). Accordingly, as the amount of fine particles such as PM accumulated in the fine particle collector 10 increases, the summed reflection intensity increases.

### (Variation 2)

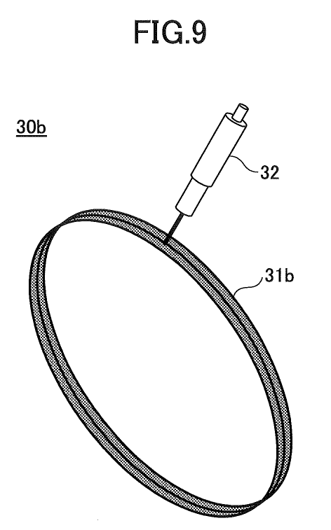

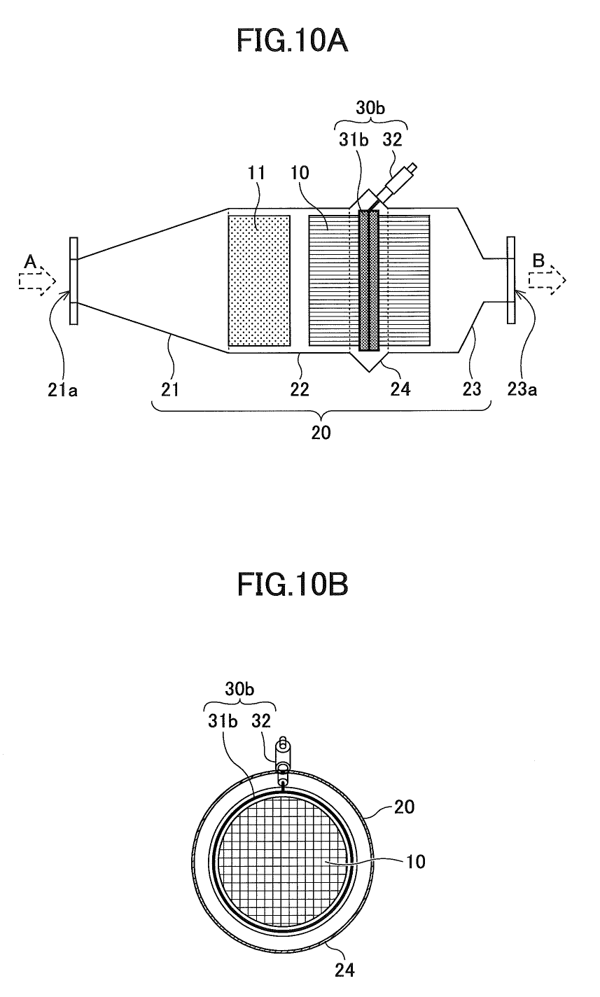

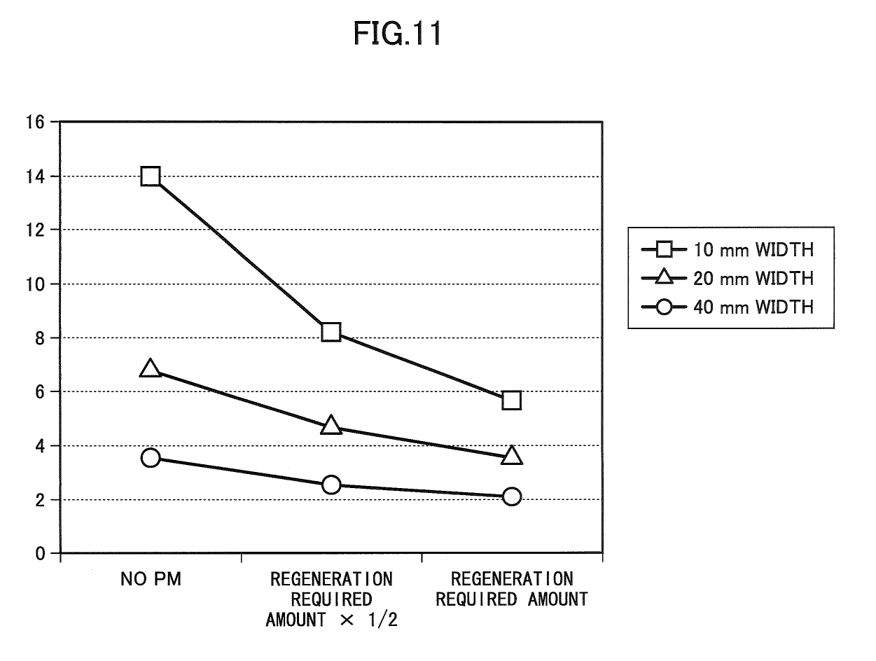

Next, a relationship between an amount of fine particles such as PM accumulated in the fine particle collector 10 and a summed reflection intensity in a case where an antenna 30b of FIG. 9 is used will be described. FIG. 10A is a drawing illustrating a structure of the exhaust gas purification apparatus that uses the antenna 30a of FIG. 9. FIG. 10B is a cross-sectional view of a part where the antenna 30b is provided. FIG. 11 illustrates a result obtained by simulating, in the exhaust gas purification apparatus using the antenna 30b of FIG. 9, the relationship between the amount of fine particles such as PM accumulated in the fine particle collector 10 and the summed reflection intensity. For convenience, the vertical axis indicates relative values. The antenna 30b of FIG. 9 is a band antenna having a belt-shaped (band-shaped) radiation part 31b. The thickness of the band-shaped radiation part 31b is approximately 1 mm.

As illustrated in FIG. 11, the width of the radiation part 31b is changed to 10 mm, 20 mm, and 40 mm. When the width of the radiation part 31b is 10 mm, the summed reflection intensity is approximately 14 in the case where no fine particles such as PM are accumulated in the fine particle collector 10 (no PM), is approximately 8 in the case where the accumulated amount is equal to half the regeneration required amount, and is approximately 5.9 in the case where fine particles such as PM are accumulated to the extent that the fine particle collector 10 needs to be regenerated (regeneration required amount). When the width of the radiation part 31b is 20 mm, the summed reflection intensity is approximately 6.8 in the case where no fine particles such as PM are accumulated in the fine particle collector 10 (no PM), is approximately 4.8 in the case where the accumulated amount is equal to half the regeneration required amount, and is approximately 3.6 in the case where fine particles such as PM are accumulated to the extent that the fine particle collector 10 needs to be regenerated (regeneration required amount). When the width of the radiation part 31b is 40 mm, the summed reflection intensity is approximately 3.8 in the case where no fine particles such as PM are accumulated in the fine particle collector 10 (no PM), is approximately 2.5 in the case where the accumulated amount is equal to half the regeneration required amount, and is approximately 2 in the case where fine particles such as PM are accumulated to the extent that the fine particle collector 10 needs to be regenerated (regeneration required amount).

Accordingly, as the amount of fine particles such as PM accumulated in the fine particle collector 10 increases, the summed reflection intensity decrease.

### (Variation 3)

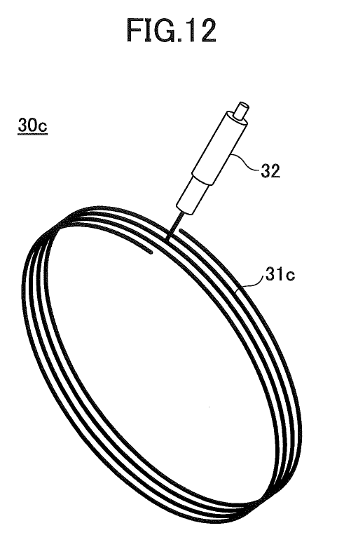

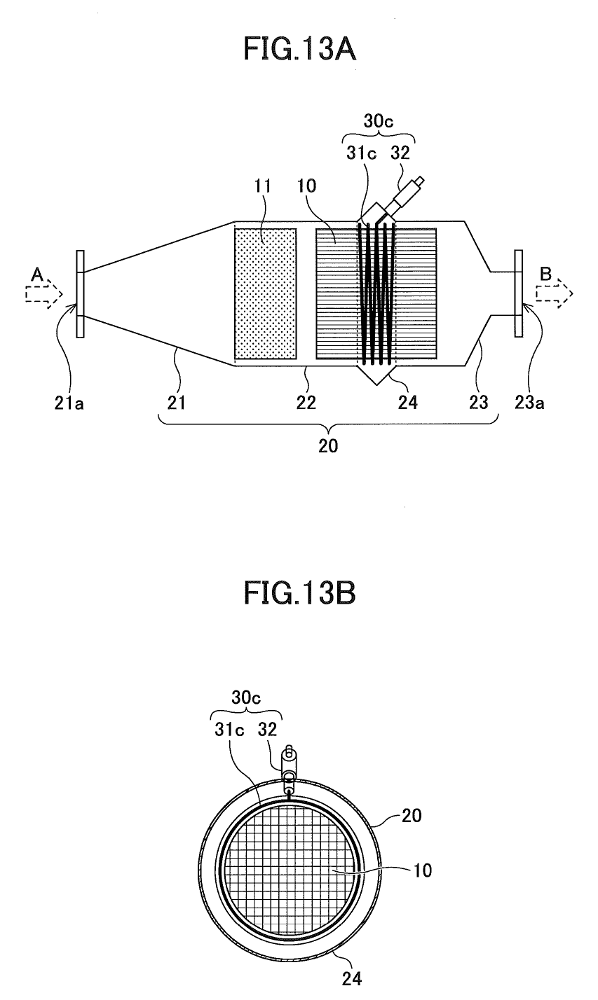

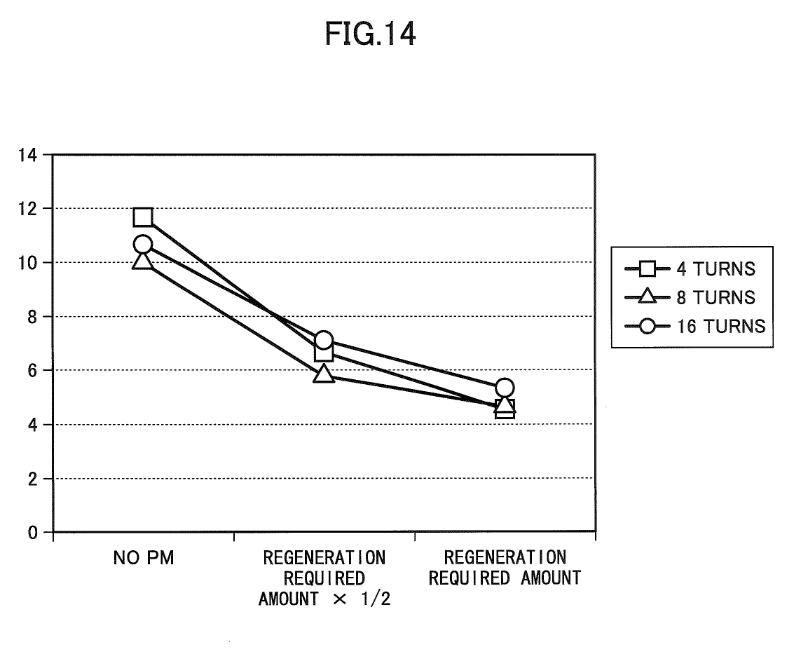

Next, a relationship between an amount of fine particles such as PM accumulated in the fine particle collector 10 and a summed reflection intensity in a case where an antenna 30c of FIG. 12 is used will be described. FIG. 13A is a drawing illustrating a structure of the exhaust gas purification apparatus that uses the antenna 30c of FIG. 12. FIG. 13B is a cross-sectional view of a part where the antenna 30c is provided. FIG. 14 illustrates a result obtained by simulating, in the exhaust gas purification apparatus using the antenna 30c of FIG. 12, the relationship between the amount of fine particles such as PM accumulated in the fine particle collector 10 and the summed reflection intensity. For convenience, the vertical axis indicates relative values. The antenna 30c of FIG. 12 is a spiral antenna having a spiral-shaped radiation part 31c. The diameter of the spiral-shaped radiation part 31c is approximately 1 mm.

As illustrated in FIG. 14, the number of turns of the spiral-shaped radiation part 31c of the antenna 30c is varied by 4 turns, 8 turns, and 16 turns. When the number of turns of the radiation part 31c is 4 turns, the summed reflection intensity is approximately 11.6 in the case where no fine particles such as PM are accumulated in the fine particle collector 10 (no PM), is approximately 6.8 in the case where the accumulated amount is equal to half the regeneration required amount, and is approximately 4.8 in the case where fine particles such as PM are accumulated to the extent that the fine particle collector 10 needs to be regenerated (regeneration required amount). When the number of turns of the radiation part 31c is 8 turns, the summed reflection intensity is approximately 10 in the case where no fine particles such as PM are accumulated in the fine particle collector 10 (no PM), is approximately 5.8 in the case where the accumulated amount is equal to half the regeneration required amount, and is approximately 4.8 in the case where fine particles such as PM are accumulated to the extent that the fine particle collector 10 needs to be regenerated (regeneration required amount). When the number of turns of the radiation part 31c is 16 turns, the summed reflection intensity is approximately 10.7 in the case where no fine particles such as PM are accumulated in the fine particle collector 10 (no PM), is approximately 7 in the case where the accumulated amount is equal to half the regeneration required amount, and is approximately 5.5 in the case where fine particles such as PM are accumulated to the extent that the fine particle collector 10 needs to be regenerated (regeneration required amount).

Accordingly, as the amount of fine particles such as PM accumulated in the fine particle collector 10 increases, the summed reflection intensity decrease.

### (Variation 4)

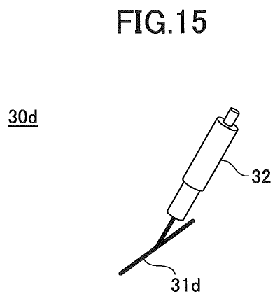

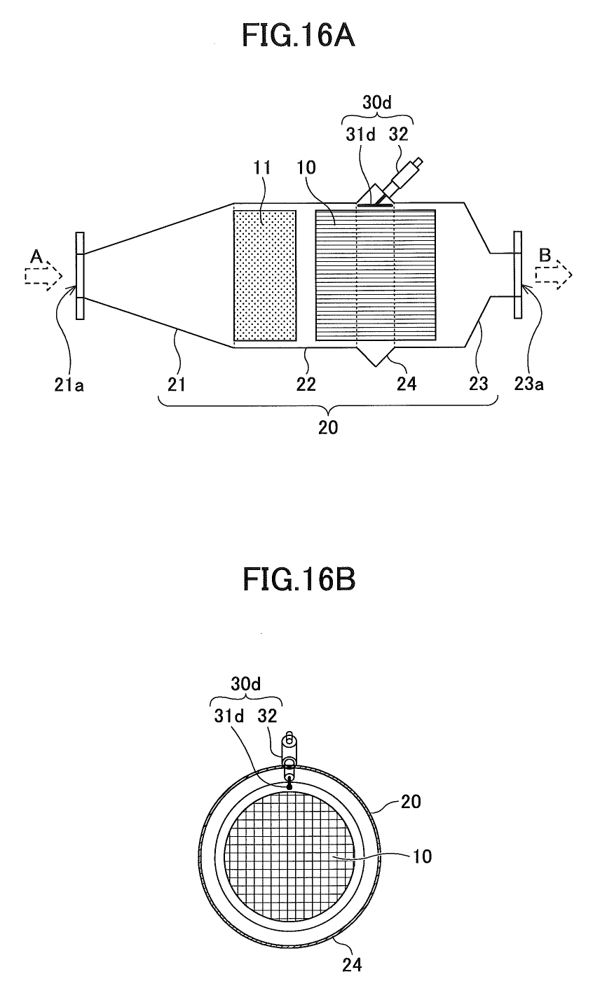

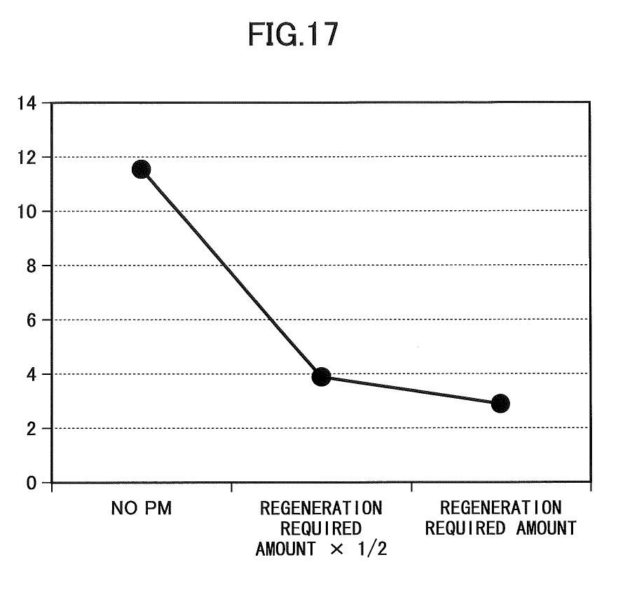

Next, a relationship between an amount of fine particles such as PM accumulated in the fine particle collector 10 and a summed reflection intensity in a case where an antenna 30d of FIG. 15 is used will be described. FIG. 16A is a drawing illustrating a structure of the exhaust gas purification apparatus that uses the antenna 30d of FIG. 15. FIG. 16B is a cross-sectional view of a part where the antenna 30d is provided. FIG. 17 illustrates a result obtained by simulating, in the exhaust gas purification apparatus using the antenna 30d of FIG. 15, the relationship between the amount of fine particles such as PM accumulated in the fine particle collector 10 and the summed reflection intensity. For convenience, the vertical axis indicates relative values. The antenna 30d of FIG. 15 is a cylinder generatrix-direction-type antenna, having a radiation part 31d that extends along the generatrix of the cylindrical housing body 22. The diameter of the radiation part 31d is 1 mm and the length of the radiation part 31d is 40 mm.

As illustrated in FIG. 17, the summed reflection intensity is approximately 11.5 in the case where no fine particles such as PM are accumulated in the fine particle collector 10 (no PM), is approximately 4 in the case where the accumulated amount is equal to half the regeneration required amount, and is approximately 2.9 in the case where fine particles such as PM are accumulated to the extent that the fine particle collector 10 needs to be regenerated (regeneration required amount). Accordingly, as the amount of fine particles such as PM accumulated in the fine particle collector 10 increases, the summed reflection intensity decreases.

### (Variation 5)

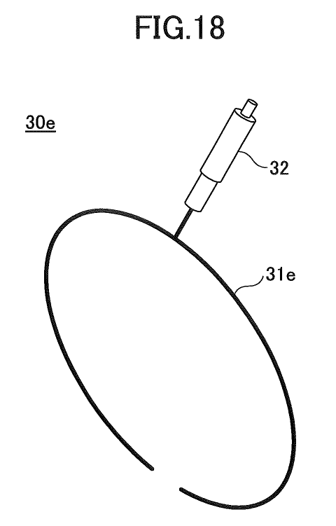

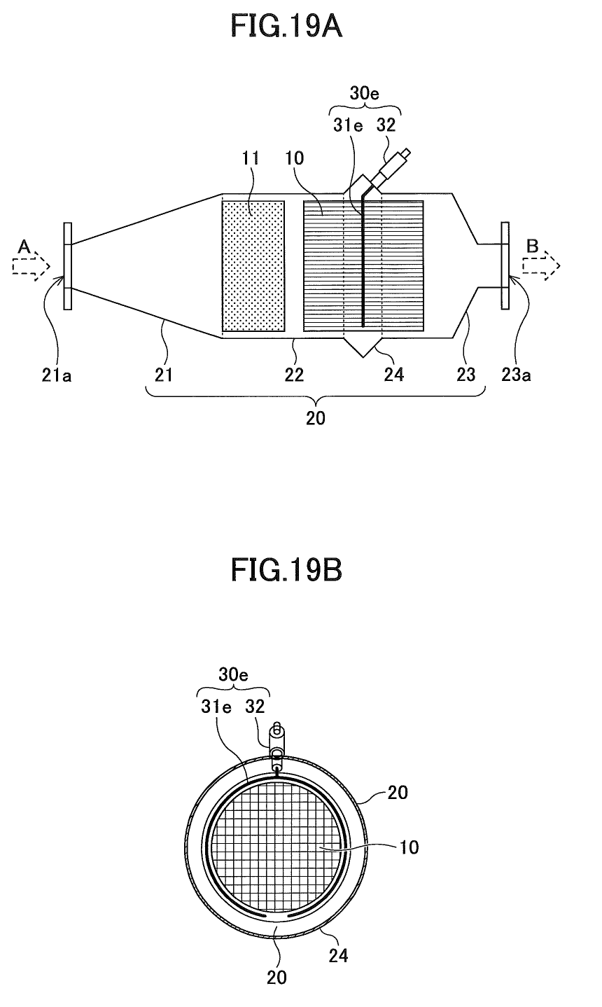

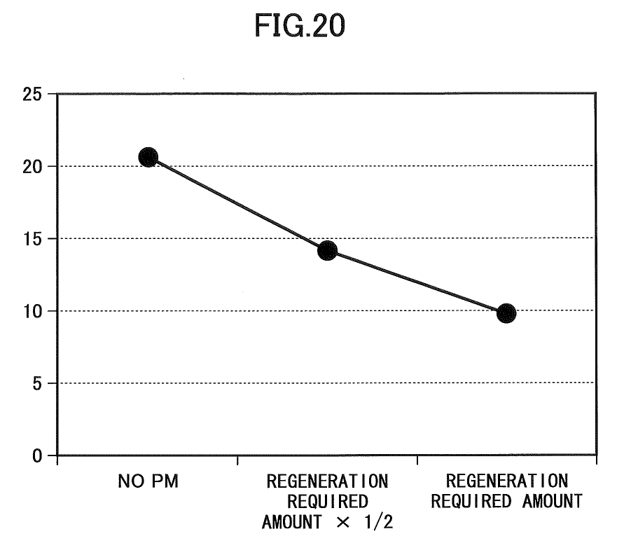

Next, a relationship between an amount of fine particles such as PM accumulated in the fine particle collector 10 and a summed reflection intensity in a case where an antenna 30e of FIG. 18 is used will be described. FIG. 19A is a drawing illustrating a structure of the exhaust gas purification apparatus that uses the antenna 30e of FIG. 18. FIG. 19B is a cross-sectional view of a part where the antenna 30e is provided. FIG. 20 illustrates a result obtained by simulating, in the exhaust gas purification apparatus using the antenna 30e of FIG. 18, the relationship between the amount of fine particles such as PM accumulated in the fine particle collector 10 and the summed reflection intensity. FIG. 20 illustrates a result obtained by simulating, in the exhaust gas purification apparatus using the antenna 30e of FIG. 18, the relationship between the amount of fine particles such as PM accumulated in the fine particle collector 10 and the summed reflection intensity. For convenience, the vertical axis indicates relative values. The antenna 30e of FIG. 18 is a circumferential-direction-type antenna having a radiation part 31e that extends in the circumferential direction of the cylindrical housing body 22. The diameter of the radiation part 31e is 1 mm and the radiation part 31e is formed along approximately the entire circumference of the cylindrical housing body 22. Further, an antenna having the above-described configuration exhibits a similar tendency even if the radiation part 31e is shorter in length, for example, half the length of the antenna illustrated in FIG. 18.

As illustrated in FIG. 20, the summed reflection intensity is approximately 21 in the case where no fine particles such as PM are accumulated in the fine particle collector 10 (no PM), is approximately 14 in the case where the accumulated amount is equal to half the regeneration required amount, and is approximately 10 in the case where fine particles such as PM are accumulated to the extent that the fine particle collector 10 needs to be regenerated (regeneration required amount). Accordingly, as the amount of fine particles such as PM accumulated in the fine particle collector 10 increases, the summed reflection intensity increases.

In the above-described embodiment and the variations, the frequencies of the microwaves are swept in the range from 2.4 GHz to 2.5 GHz. However, the present invention is not limited to this range. Microwaves of frequencies in a range of 10 MHz or more or frequencies in a range of 100 GHz or less may be used. For convenience, microwaves in the above-described frequency ranges are preferably in frequency bands called the industry science medical (ISM) bands. To be more specific, frequencies of greater than or equal to 44.66 MHz and less than or equal to 40.70 MHz, greater than or equal to 902 MHz and less than or equal to 928 MHz, greater than or equal to 2.4 GHz and less than or equal to 2.5 GHz, greater than or equal to 5.725 GHz and less than or equal to 5.875 GHz, and greater than or equal to 24 GHz and less than or equal to 24.25 GHz are preferable.

(Method for Estimating Accumulated Amount of Fine Particles such as PM)

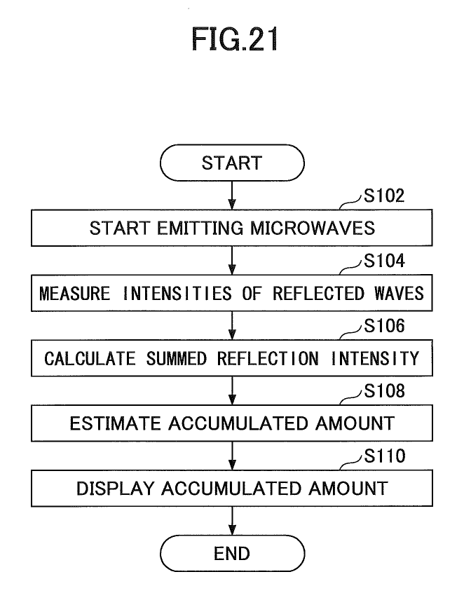

Next, referring to FIG. 21, a method for estimating the amount of fine particles such as PM accumulated in the fine particle collector 10 of the exhaust gas purification apparatus of the present embodiment will be described. The controller 70 controls this estimation method.

First, as illustrated in step 102 (S102), microwaves begin to be emitted. To be more specific, the microwave generator 50 generates microwaves by changing frequencies in a predetermined range and causes the microwaves to be emitted from, for example, the antenna 30 into the fine particle collector 10.

Next, as illustrated in step 104 (S104), the microwave detector 60 measures the intensities of reflected waves. The measured intensities of the reflected waves are sent to the controller 70.

Next, as illustrated in step 106 (S106), the intensities of the reflected waves of the frequencies in the predetermined range measured by the microwave detector 60 are summed so as to calculate a summed reflection intensity.

Next, as illustrated in step 108 (S108), an amount of fine particles such as PM accumulated in the fine particle collector 10 is estimated based on the summed reflection intensity calculated in step 106.

Next, as illustrated in step 110 (S110), the amount of the fine particles such as PM accumulated in the fine particle collector 10, which has been estimated in step 108, is displayed in a display portion (not illustrated) coupled to the controller 70.

The method for estimating the amount of fine particles such as PM accumulated in the fine particle collector 10 of the exhaust gas purification apparatus is completed.

### (Method for Regenerating Fine Particle Collector of Exhaust Gas Purification Apparatus)

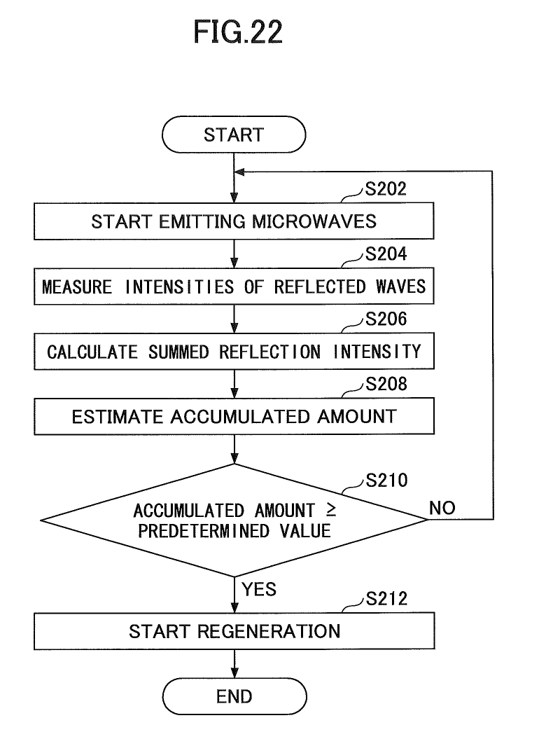

Next, referring to FIG. 22, a method for regenerating the fine particle collector 10 of the exhaust gas purification apparatus will be described. The controller 70 controls this regeneration method.

First, as illustrated in step 202 (S202), microwaves begin to be emitted. To be more specific, the microwave generator 50 generates microwaves by changing frequencies in a predetermined range and causes the microwaves to be emitted from, for example, the antenna 30 into the fine particle collector 10.

Next, as illustrated in step 204 (S204), the microwave detector 60 measures the intensities of reflected waves. The measured intensities of the reflected waves are sent to the controller 70.

Next, as illustrated in step 206 (S206), the intensities of the reflected waves of the frequencies in the predetermined range measured by the microwave detector 60 are summed so as to calculate a summed reflection intensity.

Next, as illustrated in step 208 (S208), the accumulated amount of fine particles such as PM accumulated in the fine particle collector 10 is estimated based on the summed reflection intensity calculated in step 206.

Next, as illustrated in step 210 (S210), it is determined whether the accumulated amount estimated in step 208 is greater than or equal to a predetermined value. To be more specific, in a case where the accumulated amount estimated in step 208 is greater than or equal to the predetermined value, the method proceeds to step 212. In a case where the accumulated amount estimated in step 208 is less than the predetermined value, the method returns to step 202.

Next, as illustrated in step 212 (S212), the fine particle collector 10 of the exhaust gas purification apparatus begins to be regenerated. To be more specific, diesel oil is injected into the fine particle collector 10 such that the fine particles such as PM accumulated in the fine particle collector 10 are forcibly burned and thereby the fine particles such as PM accumulated in the fine particle collector 10 are removed. Further, during the process of regenerating the fine particle collector 10, steps 202 through 208 may be performed and the accumulated amount may be estimated. Upon the accumulated amount being determined to be approximately zero, it may be detected as the end of the regeneration of the fine particle collector 10, and as a result, the regeneration of the fine particle collector 10 may be ended.

The method for regenerating the fine particle collector 10 of the exhaust gas purification apparatus of the present embodiment is completed.

Further, in the method for regenerating the fine particle collector 10 of the exhaust gas purification apparatus of the present embodiment, step 208 may be omitted and whether or not to regenerate the fine particle collector 10 may be determined based on the summed reflection intensity calculated in step 206. To be more specific, in the example illustrated in FIG. 5, it is determined whether the summed reflection intensity is greater than or equal to 123. When the summed reflection intensity is greater than or equal to the predetermined value, the method may proceed to step 212 and the fine particle collector may be forcibly regenerated. When the summed reflection intensity is less than the predetermined value, the method may return to step 202. Further, in the antenna having the configuration illustrated in FIG. 6, regeneration of the fine particle collector 10 is determined based on whether the summed reflection intensity is greater than or equal to the predetermined value as described above. Conversely, in the antennas having the configurations illustrated in FIG. 9, FIG. 12, FIG. 15, and FIG. 18, regeneration of the fine particle collector 10 is determined based on whether the summed reflection intensity is less than or equal to the predetermined value.

According to the fine particle detector disclosed herein, it is possible to estimate the amount of fine particles such as PM accumulated in a DPF as accurately as possible without being affected by fine particles such as PM and NOx contained in exhaust gas.

Although the embodiments have been specifically described above, the present invention is not limited to the specific embodiments and various modifications and variations may be made without departing from the scope of the present invention.

With regard to the embodiments described above, the following additional statements are further disclosed.

### (Additional Statement 1)

A fine particle detector includes an antenna, an electromagnetic wave generator configured to supply electromagnetic waves to the antenna, an electromagnetic wave detector configured to detect reflected waves of the electromagnetic waves emitted from the antenna, and a controller configured to estimate, based on intensities of the reflected waves detected by the electromagnetic wave detector, an accumulated amount of fine particles.

### (Additional Statement 2)

The fine particle detector according to additional statement 1, wherein the electromagnetic wave generator is configured to continuously generate electromagnetic waves in a predetermined frequency range by changing frequencies so as to emit the electromagnetic waves from the antenna, and the controller is configured to sum the intensities of the reflected waves detected by the electromagnetic wave detector so as to calculate a summed reflection intensity, and to estimate, based on the summed reflection intensity, the accumulated amount of the fine particles.

### (Additional Statement 3)

The fine particle detector according to additional statement 1 or 2, wherein the antenna includes a loop antenna, a ring antenna, a band antenna, a spiral antenna, an antenna extending in a cylinder generatrix direction, or an antenna extending in a circumferential direction.

### (Additional Statement 4)

The fine particle detector according to any one of additional statements 1 to 3, wherein frequencies of the electromagnetic waves are greater than or equal to 10 MHz and less than or equal to 100 GHz.

### (Additional Statement 5)

An exhaust gas purification apparatus includes a fine particle collector configured to collect fine particles included in exhaust gas, a housing configured to cover the fine particle collector, an antenna disposed between the housing and the fine particle collector, an electromagnetic wave generator configured to supply electromagnetic waves to the antenna, and an electromagnetic wave detector configured to detect reflected waves of the electromagnetic waves emitted from the antenna.

### (Additional Statement 6)

The exhaust gas purification apparatus according to additional statement 5, including a controller configured to estimate, based on intensities of the reflected waves detected by the electromagnetic wave detector, an accumulated amount of fine particles accumulated in the fine particle collector.

### (Additional Statement 7)

The exhaust gas purification apparatus according to additional statement 6, wherein the electromagnetic wave generator is configured to continuously generate electromagnetic waves in a predetermined frequency range by changing frequencies so as to emit the electromagnetic waves from the antenna, and the controller is configured to sum the intensities of the reflected waves detected by the electromagnetic wave detector so as to calculate a summed reflection intensity, and to estimate, based on the summed reflection intensity, the accumulated amount of the fine particles accumulated in the fine particle collector.

### (Additional Statement 8)

The exhaust gas purification apparatus according to additional statement 6 or 7, wherein the controller is configured to control regeneration of the fine particle collector in response to the accumulated amount of the fine particles accumulated in the fine particle collector being greater than or equal to a predetermined value.

### (Additional Statement 9)

The exhaust gas purification apparatus according to any one of additional statement 5 to 8, wherein the antenna includes a loop antenna, a ring antenna, a band antenna, a spiral antenna, an antenna extending in a cylinder generatrix direction, or an antenna extending in a circumferential direction.

### (Additional Statement 10)

The exhaust gas purification apparatus according to any one of additional statement 5 to 9, wherein a cushioning material is disposed between the housing and the fine particle collector, and the antenna is placed in the cushioning material.

### (Additional Statement 11)

The exhaust gas purification apparatus according to any one of additional statement 5 to 10, wherein frequencies of the electromagnetic waves are greater than or equal to 10 MHz and less than or equal to 100 GHz.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention have been described in detail, it should be understood that the various changes, substitutions, and alterations could be made hereto without departing from the spirit and scope of the invention.

What is claimed is:

1. A fine particle detector comprising:
an antenna;
an electromagnetic wave generator configured to supply electromagnetic waves to the antenna;
an electromagnetic wave detector configured to detect reflected waves of the electromagnetic waves emitted from the antenna; and
a controller configured to estimate, based on intensities of the reflected waves detected by the electromagnetic wave detector, an accumulated amount of fine particles.

2. The fine particle detector according to claim 1,
wherein the electromagnetic wave generator is configured to continuously generate the electromagnetic waves in a predetermined frequency range by changing frequencies so as to emit the electromagnetic waves from the antenna, and
the controller is configured to sum the intensities of the reflected waves detected by the electromagnetic wave detector so as to calculate a summed reflection intensity, and to estimate, based on the summed reflection intensity, the accumulated amount of the fine particles.

3. The fine particle detector according to claim 1, wherein the antenna includes a loop antenna, a ring antenna, a band antenna, a spiral antenna, an antenna extending in a cylinder generatrix direction, or an antenna extending in a circumferential direction.

4. The fine particle detector according to claim 1, wherein frequencies of the electromagnetic waves are greater than or equal to 10 MHz and less than or equal to 100 GHz.

5. An exhaust gas purification apparatus comprising:
a fine particle collector configured to collect fine particles included in exhaust gas;
a housing configured to cover the fine particle collector;
an antenna disposed between the housing and the fine particle collector;
an electromagnetic wave generator configured to supply electromagnetic waves to the antenna; and
an electromagnetic wave detector configured to detect reflected waves of the electromagnetic waves emitted from the antenna.

6. The exhaust gas purification apparatus according to claim 5, comprising a controller configured to estimate, based on intensities of the reflected waves detected by the electromagnetic wave detector, an accumulated amount of fine particles accumulated in the fine particle collector.

7. The exhaust gas purification apparatus according to claim 6,
wherein the electromagnetic wave generator is configured to continuously generate electromagnetic waves in a predetermined frequency range by changing frequencies so as to emit the electromagnetic waves from the antenna; and
the controller is configured to sum the intensities of the reflected waves detected by the electromagnetic wave detector so as to calculate a summed reflection intensity, and to estimate, based on the summed reflection intensity, the accumulated amount of the fine particles accumulated in the fine particle collector.

8. The exhaust gas purification apparatus according to claim 6, wherein the controller is configured to control regeneration of the fine particle collector in response to the accumulated amount of the fine particles accumulated in the fine particle collector being greater than or equal to a predetermined value.

9. The exhaust gas purification apparatus according to claim 5, wherein the antenna includes a loop antenna, a ring antenna, a band antenna, a spiral antenna, an antenna extending in a cylinder generatrix direction, or an antenna extending in a circumferential direction.

10. The exhaust gas purification apparatus according to claim 5, wherein a cushioning material is disposed between the housing and the fine particle collector, and the antenna is placed in the cushioning material.

11. The exhaust gas purification apparatus according to claim 5, wherein frequencies of the electromagnetic waves are greater than or equal to 10 MHz and less than or equal to 100 GHz.
